(19) United States
(12) Patent Application Publication
(10) Pub. No.: US 2015/0257072 A1
(43) Pub. Date: Sep. 10, 2015

(54) BASE STATION AND TERMINAL

(71) Applicant: SHARP KABUSHIKI KAISHA, Osaka (JP)

(72) Inventors: Kozue Yokomakura, Osaka-shi (JP); Takashi Yoshimoto, Osaka-shi (JP); Ryota Yamada, Osaka-shi (JP); Katsuya Kato, Osaka-shi (JP)

(21) Appl. No.: 14/428,040

(22) PCT Filed: Sep. 3, 2013
(86) PCT No.: PCT/JP2013/073617

§ 371 Date: Mar. 13, 2015

(30) Foreign Application Priority Data
Sep. 25, 2012 (JP) 2012-210880

(51) Int. Cl. H04W 36/30; H04W 4/02; H04W 36/08

(52) U.S. Cl. CPC H04W 36/30; H04W 36/08; H04W 4/02; H04W 88/08

(57) ABSTRACT

In a wireless communication system in which a base station and a terminal communicate with each other, the terminal switches connection destinations efficiently. The terminal includes a positional information measurement unit, notifies the base station of positional information, and based on connection base station information transmitted from the base station, generates a synchronization signal of the connection base station information, and communicates with the connection base station. The terminal transmits terminal information to a first base station, and starts communication with a second base station based on information notified from the first base station. The terminal information is positional information, which is obtained by the GPS or a positioning reference signal.

### TECHNICAL FIELD

The present invention relates to a base station and a terminal.

### BACKGROUND ART

In a wireless communication system for mobile telephones and the like, a plurality of base stations (evolved Node Bs (eNBs)) are arranged so as to cover a wide area entirely, and each base station connects to a terminal (user equipment (UE)) to perform data communication and manages the connection. A coverage in which each base station can connect to a terminal (communication area) is referred to as a cell, each of areas obtained by dividing a cell into several coverages is referred to as a sector, and each base station manages the connection with a terminal with a cell or sector as a unit.

In recent years, there has been a demand for traffic distribution with an increase in the traffic volume due to the widespread use of smartphones and the like. For this reason, the 3rd Generation Partnership Project (3GPP) has proposed that in a cell (for example, a macro cell; referred to below as a macro cell) that has a large cell radius and in which a wide domain is provided as a communication area, a cell (such as a pico cell, a femto cell, or a small cell; referred to below as a small cell) configured with a low power base station (such as a low power node (LPN), a pico cell base station, or a femto cell base station) be arranged (NPL 1). The low power base station refers to a base station with smaller transmission power than that of a macro cell base station.

### CITATION LIST

### Non Patent Literature

NPL 1: Ericsson, RWS-120003, Views on Rel-12, June, 2012.

### SUMMARY OF INVENTION

### Technical Problem

NPL 1 discloses arrangement of a plurality of small cells in a macro cell, but does not disclose, for example, a specific implementation means for connection destination switching, such as a procedure for changing a terminal connection destination from a base station of a macro cell to a base station of a small cell and a method for deciding a new connection destination.

Further, if a method used in the current cellular system (for example, a handover or a cell search) is applied, a terminal detects synchronization signals transmitted from surrounding base stations, measures reception power of each cell, and specifies the base station of the cell with the highest reception power as a new connection destination. In this case, the terminal measures reception power of all cells that can be detected, and therefore needs to detect many cells, particularly in an environment in which small cells are closely arranged, thereby causing a problem with the terminal battery drain or the like. The terminal needs to notify a core network of information required for handover processing, thereby causing a problem in that connection destinations cannot be switched quickly.

The present invention has been made in light of the above problems and provides a base station and a terminal that enable the terminal to switch connection destinations efficiently.

### Solution to Problem

To solve the problems described above, a base station and a terminal according to the present invention have configurations as described below.

(1) A terminal according to one aspect of the present invention is a terminal that communicates with a base station, and the terminal transmits terminal information to a first base station, and starts communication with a second base station based on information notified from the first base station.

(2) Moreover, a terminal according to one aspect of the present invention is the above terminal, and the terminal information is positional information.

(3) Moreover, a terminal according to one aspect of the present invention is the above terminal, and the positional information is information obtained by the GPS.

(4) Moreover, a terminal according to one aspect of the present invention is the above terminal, and the positional information is information obtained by a positioning reference signal.

(5) Moreover, a terminal according to one aspect of the present invention is the above terminal, and the terminal information is reception quality.

(6) Moreover, a terminal according to one aspect of the present invention is the above terminal, and the terminal performs a cell search and synchronization in a case that the terminal starts communication with the first base station, and the terminal performs synchronization in a case that the terminal is instructed to communicate with the second base station.

(7) Moreover, a terminal according to one aspect of the present invention is the above terminal, and the terminal synchronizes with a plurality of second base stations notified from the first base station, and measures reception quality.

(8) Moreover, a terminal according to one aspect of the present invention is the above terminal, and the terminal notifies the first base station of information about the measured reception quality of all second base stations.

(9) Moreover, a terminal according to one aspect of the present invention is the above terminal, and in a case that reception quality in communication with the second base station becomes smaller than or equal to a predetermined value, the terminal transmits terminal information to the first base station, and starts communication with a third base station based on information transmitted from the first base station.

(10) Moreover, a base station according to one aspect of the present invention is a base station that controls a terminal, and the base station receives terminal information notified from the terminal, and transmits connection base station information to the terminal.

(11) Moreover, a base station according to one aspect of the present invention is the above base station, and the terminal information is positional information.

(12) Moreover, a base station according to one aspect of the present invention is the above base station, and the positional information is information obtained by the GPS.

(13) Moreover, a base station according to one aspect of the present invention is the above base station, and the positional information is information obtained by a positioning reference signal.

(14) Moreover, a base station according to one aspect of the present invention is the above base station, and the terminal information is reception quality.

(15) Moreover, a base station according to one aspect of the present invention is the above base station, and the base station grasps positional information from the terminal information, and decides the connection base station information based on the positional information.

(16) Moreover, a base station according to one aspect of the present invention is the above base station, and the connection base station information is decided based on a distance between the terminal and the second base station.

(17) Moreover, a base station according to one aspect of the present invention is a base station that controls a terminal, and the base station receives the terminal information notified from the terminal, transmits candidate base stations to the terminal, receives reception quality from the terminal, and transmits connection base station information to the terminal.

### Advantageous Effects of Invention

According to the present invention, when a terminal changes a connection destination, connection destinations can be switched efficiently.

### BRIEF DESCRIPTION OF DRAWINGS

FIG. 1 is a schematic view illustrating a configuration example of a communication system in a first embodiment.

FIG. 2 is a schematic view illustrating a configuration example of a communication system in which a macro cell base station 100 manages a connection with a terminal 300 with a sector as a unit.

FIG. 3 is a sequence diagram illustrating an example of a processing flow in the communication system in the first embodiment.

FIG. 4 is a schematic view illustrating a configuration example of a communication system indicating another aspect of the first embodiment.

FIG. 5 is a schematic block diagram illustrating a configuration example of the macro cell base station 100 and a low power base station 200-x in the first embodiment.

FIG. 6 is a schematic block diagram illustrating a configuration example of the terminal 300 in the first embodiment.

FIG. 7 is a sequence diagram illustrating an example of a processing flow in a communication system in a second embodiment.

FIG. 8 is a schematic block diagram illustrating a configuration example of the terminal 300 in the second embodiment.

FIG. 9 is a schematic view illustrating a configuration example of a communication system in a third embodiment.

FIG. 10 is a sequence diagram illustrating an example of a processing flow in the communication system in the third embodiment.

### DESCRIPTION OF EMBODIMENTS

Embodiments of the present invention will now be described in detail with reference to the drawings.

### First Embodiment

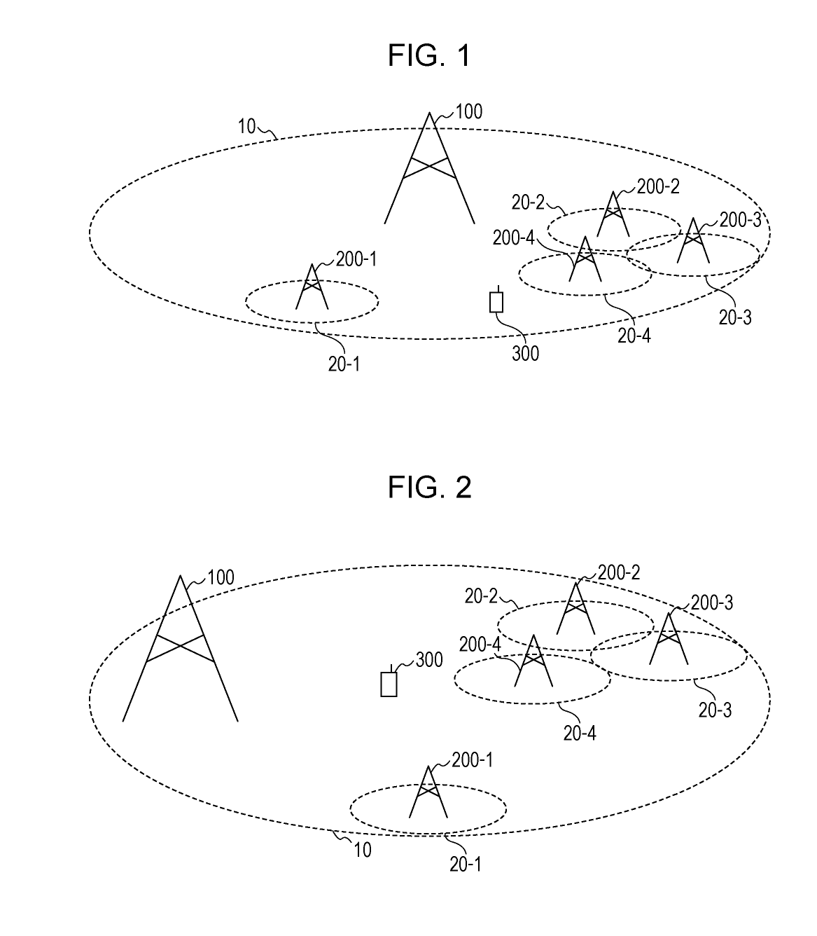

FIG. 1 is a schematic view illustrating a configuration example of a communication system in a first embodiment. As illustrated in FIG. 1, in the communication system in the present embodiment, a macro cell 10 (macro area) in which a wide domain is provided as a communication area by a macro cell base station (first base station) 100 includes a small cell 20-x in which a domain configured with a low power base station 200-x (x is any positive integer, 1≦x≦4 in the examples in the present embodiment) is provided as a communication area. As illustrated in FIG. 1, it is assumed that a terminal 300 is present in any position in the macro area.

A difference between the macro cell base station and the low power base station is assumed to be a difference in transmission power, but is not limited thereto. As in a pico cell base station and a femto cell base station, base stations included in small cells may cover different communication areas (cells), but the present invention can be applied to such an environment. The macro cell base station and the low power base station are connected with a backhaul line, and a wired type such as an optical fiber or an X2 interface may be used, or a wireless type such as a relay base station may be used.

In the embodiment below, a method is described in which the macro cell base station covering the macro area manages a terminal connection and assists in a connection to the low power base station, but a distinction between the macro cell base station and the low power base station may be made not only by transmission power, but also by a backward-compatible cell that supports a method that has already been launched and a backward-incompatible cell that is newly defined.

The present embodiment assumes the communication system in FIG. 1 as an example, but the present embodiment can be applied to any communication system in which at least one small cell is configured in a macro cell. The number of cells, the number of base stations, the number of terminals, the types of cells (for example, pico cells, femto cells, or the like), the types of base stations, and the like are not limited to the present embodiment. A communication system may be provided in which the macro cell base station 100 manages a connection with the terminal 300 with a sector as a unit. FIG. 2 is a schematic view illustrating a configuration example of a communication system in which the macro cell base station 100 manages a connection with the terminal 300 with a sector as a unit. As in FIG. 2, the macro cell 10 is configured with unidirectional sectors for the macro cell base station 100, and at least one small cell 20-x is arranged in the macro cell 10. These apply not only to the first embodiment, but also to other embodiments. In FIG. 1, the small cells overlap completely in the macro cell, but are not limited thereto; the small cells may overlap partially, or may not overlap.

In the present embodiment, the base stations (the macro cell base station 100 and the low power base station 200-x) of the cells periodically transmit a synchronization signal (SS), a tracking signal, and a measurement signal (for example, a cell-specific reference signal, a common pilot signal, or the like). The synchronization signal is, for example, a signal defined in the Third Generation Partnership Project (3GPP), such as a primary SS (PSS) or a secondary SS (SSS), which is used to search for a carrier frequency or a cell ID (cell search). The tracking signal is a signal used to identify a sample point of a receive signal more accurately than the synchronization signal. The measurement signal is a signal used to measure reception quality. All base stations do not always have to transmit all of these signals. For example, the base stations may use a method for transmitting only some signals, such as transmitting only the tracking signal and the measurement signal, or may change the signal format of each signal. The macro cell base station 100 and the low power base station 200-x may use different synchronization methods; for example, the macro cell base station may use a method that maintains backward compatibility and the low power base station may use a new method (referred to as a new carrier type (NCT) in the 3GPP, for example). Therefore, for example, the macro cell base station 100 may use a signal format in which all signals are included, while the low power base station 200-x may uses a signal format in which only the tracking signal and the measurement signal are included. The tracking signal and the measurement signal may be the same signal, and the tracking signal and the measurement signal are assumed below to be in the same signal format. The macro cell base station and the low power base station are assumed below to use different frequencies, but are not limited thereto.

In the embodiments according to the present invention, a search for a carrier frequency and a search for a cell ID are defined as a cell search and identification of a sample point is defined as synchronization, but the cell search and the synchronization are essentially identical provided that similar processing is performed.

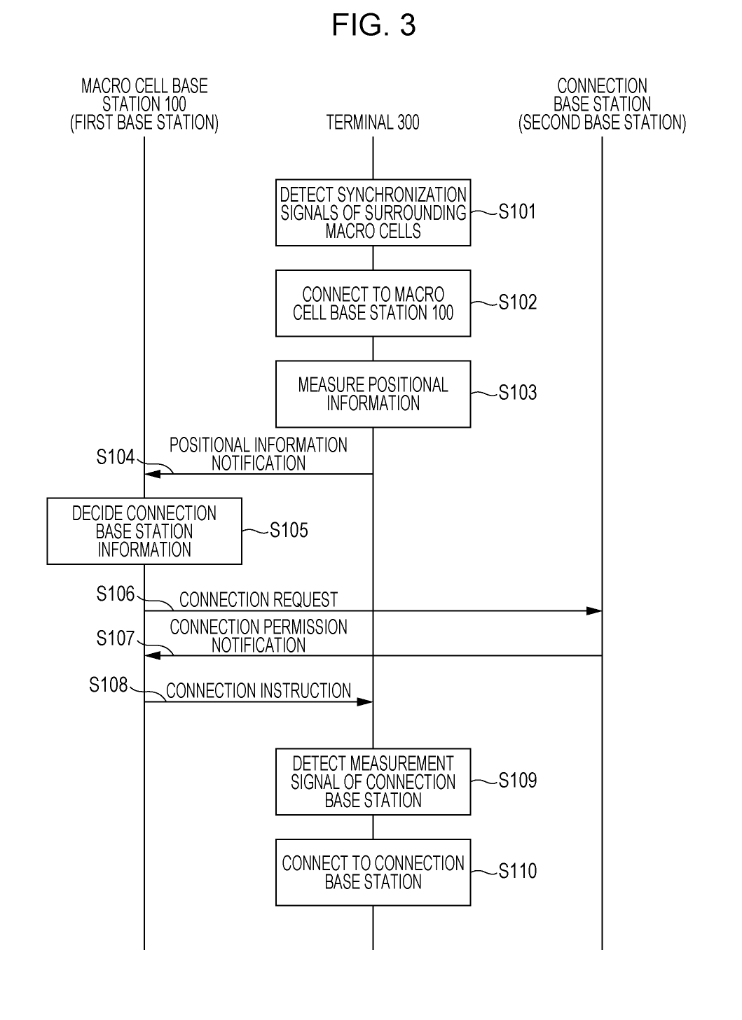

A processing flow in the present embodiment will first be described. FIG. 3 is a sequence diagram illustrating an example of the processing flow in the communication system in the present embodiment. In FIG. 3, a connection base station (second base station) indicates a base station that becomes a new connection destination, which is one base station of the low power base stations 200-x.

The terminal 300 detects the synchronization signal transmitted from the macro cell base station 100 (that is, the synchronization signal used to perform communication in the macro cell 10), among the synchronization signals transmitted from the base stations (step S101). At this time, the terminal 300 detects the synchronization signal of a frequency to be used by the macro cell 10 with reference to a frequency allocation for each cell determined in the system. As a method for searching for the synchronization signal of the macro cell 10, for example, a method is used in which replicas of synchronization signals are generated using all candidate cell IDs and a search is made for a cell ID having the highest correlation with the received synchronization signals. The synchronization signal of the macro cell 10 may be determined from a difference in signal format between the macro cell 10 and the small cell 20-x. Then, the terminal 300 connects to the macro cell base station 100 (step S102).

The terminal 300 measures positional information (terminal information) of the terminal 300 (step S103) The positional information has only to be information indicating a geographical position of the terminal 300 or information indicating a relative position of the terminal 300. The information indicating a geographical position may be, for example, information measured using the Global Positioning System (GPS), and the information indicating a relative position may be, for example, information measured using a positioning reference signal or the like transmitted from the macro cell base station 100, as in Long Term Evolution (LTE) and LTE-Advanced (LTE-A). In addition to the positional information, reception quality between the terminal 300 and each base station measured using a cell-specific reference signal may be used. Processing in step S103 may be performed before step S101 and step S102, at any timing at which the terminal 300 can measure positional information.

The terminal 300 notifies the macro cell base station 100 of the positional information (step S104).

The macro cell base station 100 decides a connection base station based on the positional information notified from the terminal 300 (step S105). It is preferable that the macro cell base station 100 calculates a distance between the positional information of the terminal 300 and each low power base station 200-x, and provides the cell ID of the low power base station 200-x having the shortest distance as connection base station information. For example, in FIG. 1, when the distance from the terminal 300 to a low power base station 200-4 is the shortest, connection base station information is the cell ID of a small cell 20-4. The connection base station information has only to be information with which a cell or a base station can be identified as a connection destination, and is not limited to a cell ID.

The macro cell base station 100 may measure positional information of the terminal 300, and decide a connection base station in consideration of the measurement result. For example, the macro cell base station 100 measures positional information using a reference signal and a control signal transmitted by the terminal 300. This enables the macro cell base station 100 to decide a connection base station using the positional information notified from the terminal 300 and the positional information measured by the macro cell base station 100.

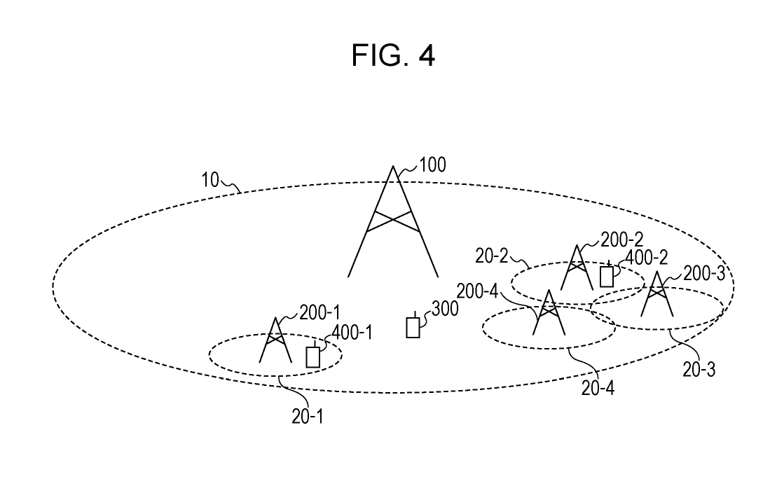

In step S105, the macro cell base station 100 may decide a connection base station in consideration of a connection state of each base station in addition to the positional information. FIG. 4 is a schematic view illustrating a configuration example of a communication system indicating another aspect of the first embodiment. For example, as in FIG. 4, when a terminal 400-1 and a terminal 400-2 are connected to a low power base station 200-1 and a low power base station 200-2, respectively, and no terminals are connected to low power base stations 200-3 and 200-4, either of the low power base stations to which no terminals are connected (low power base station 200-3 and low power base station 200-4) is specified as a connection base station, whichever has a shorter distance to the terminal 300.

The macro cell base station 100 notifies the connection base station of a connection request (for example, a handover request) through the backhaul line (step S106). The connection base station determines whether a connection is possible, and notifies the macro cell base station 100 of a permission notification (for example, handover request ACK/NACK) (step S107). When a connection is possible, the connection base station makes preparations for a connection, such as scheduling.

The macro cell base station 100 instructs the terminal 300 to change the connection destination from the macro cell base station 100 to the connection base station (step S108).

The terminal 300 detects the synchronization signal and the measurement signal of the connection base station (step S109). As a method for detecting the signals of the connection base station, a method similar to that in step S101 may be used, or if a signal format is different, synchronization processing based on the signal format may be performed. The synchronization signals of a carrier frequency of the connection base station may be detected, or the signals of the connection base station may be determined from the cell ID of the connection base station, a difference in signal format in each cell, or the like. Finally, the terminal 300 connects to the connection base station (step S110).

Thus, in the present embodiment, the terminal 300 connects to the macro cell base station 100, and notifies the macro cell base station 100 of the positional information of the terminal 300. The macro cell base station 100 specifies the low power base station 200-x selected based on a distance to the terminal 300 as a connection base station (new connection destination), among the low power base stations 200-x, and the terminal 300 switches the connection destination from the macro cell base station 100 to the connection base station. If the connection is switched from a macro cell base station to a low power base station using a cell search in the related art, a terminal needs to detect signals from all base stations that can be detected. However, when the present embodiment is used, a terminal has only to detect a synchronization signal from a macro cell base station and a measurement signal of a connection base station specified by the macro cell base station, and it is therefore possible to reduce signal detection processing and change the connection destination efficiently.

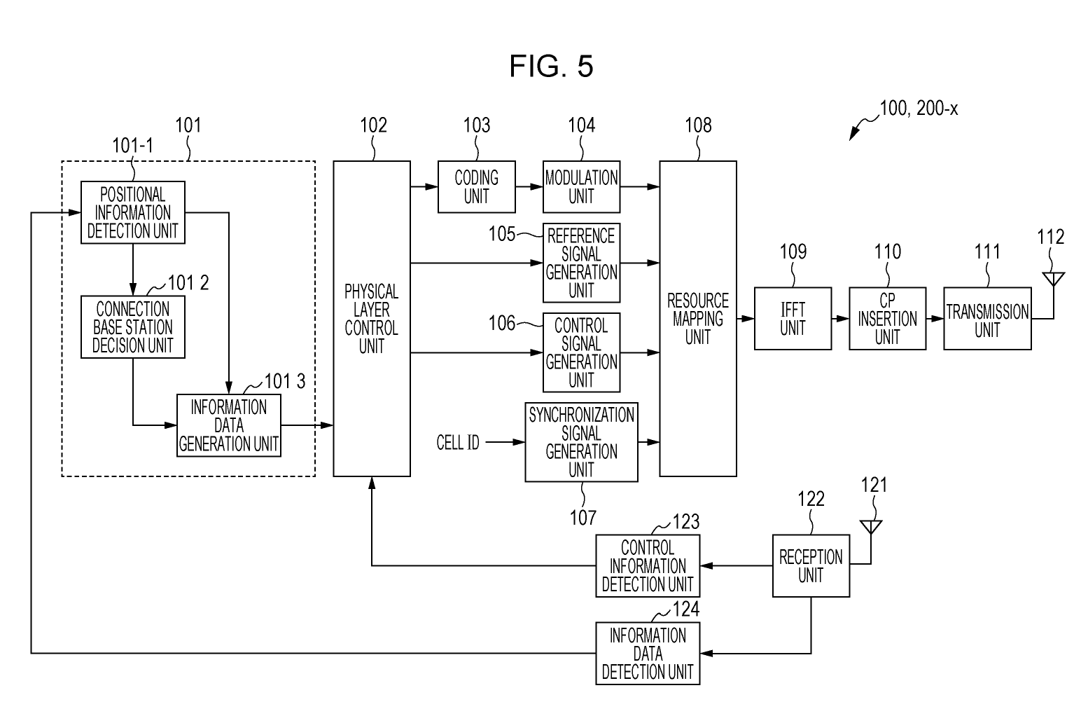

FIG. 5 is a schematic block diagram illustrating a configuration example of the macro cell base station 100 and the low power base station 200-x in the first embodiment. The macro cell base station 100 in the present embodiment will be described with reference to FIG. 5.

The macro cell base station 100 includes a positional information detection unit 101-1, a connection base station decision unit 101-2, an information data generation unit 101-3, a physical layer control unit 102, a coding unit 103, a modulation unit 104, a reference signal generation unit 105, a control signal generation unit 106, a synchronization signal generation unit 107, a resource mapping unit 108, an IFFT unit 109, a CP insertion unit 110, a transmission unit 111, a transmit antenna unit 112, a receive antenna unit 121, a reception unit 122, a control information detection unit 123, and an information data detection unit 124. A combination of the positional information detection unit 101-1, the connection base station decision unit 101-2, and the information data generation unit 101-3 is referred to as a higher layer 101. When part or all of the base station 100 is contained on a chip as an integrated circuit, a chip control circuit (not illustrated) that controls the functional blocks is provided. One transmit antenna and one receive antenna are illustrated in FIG. 5, but a plurality of transmit antennas and a plurality of receive antennas may be provided.

In an uplink, the macro cell base station 100 receives a signal transmitted by the terminal 300 through the receive antenna unit 121. The signal received by the macro cell base station 100 includes a control signal, an upward data signal, and the like.

The control signal includes, for example, information about parameters for a transmit signal to be transmitted in a downlink by the base station 100. The information about parameters for a transmit signal includes a channel quality indicator (CQI), rank and spatial multiplexing (rank indicator (RI)) in MIMO transmission, other downlink scheduling information, and the like. The scheduling refers to a decision about at which time (timing) and in which frequency band certain data is to be transmitted. The scheduling information refers to information about the decided time and frequency band. For example, in LTE and LTE-A, the scheduling refers to a decision about to which resource block information data or the like is to be allocated. A resource block in OFDM transmission is a signal allocation unit configured with a collection of a plurality of resource elements, each of which is a minimum unit in which a signal consisting of one subcarrier and one OFDM symbol is arranged. The control signal may include positional information. The control signal is transmitted using an uplink control channel (physical uplink control channel (PUCCH)) or the like.

The upward data signal includes information required for the higher layer 101. In the present embodiment, positional information is included in the upward data signal. The control signal of the higher layer 101 is transmitted using an uplink shared channel (physical uplink shared channel (PUSCH)) or the like.

The reception unit 122 down-converts the received signal to a frequency band in which digital signal processing such as signal detection processing is possible (radio frequency conversion), and then performs filtering processing. The reception unit 122 converts the signal subjected to filtering processing from an analog signal to a digital signal (analog to digital conversion (A/D conversion)), outputs the control signal to the control information detection unit 123, and outputs the upward data signal to the information data detection unit 124.

The control information detection unit 123 performs demodulation processing, decoding processing, and the like for the control signal input from the reception unit 122, detects control information, and outputs the control information to the physical layer control unit 102.

The information data detection unit 124 performs demodulation processing, decoding processing, and the like for the upward data signal input from the reception unit 122, detects upward information data, and outputs the upward information data to the higher layer 101 (positional information detection unit 101-1). The upward information data may include the positional information transmitted from the terminal 300 (step S104 in FIG. 3).

The higher layer 101 acquires the upward information data input from the information data detection unit 124. The higher layer is assumed to include a radio rink control (RRC) layer.

The positional information detection unit 101-1 detects the positional information from the upward information data notified from the terminal 300, and outputs the positional information to the connection base station decision unit 101-2. The connection base station decision unit 101-2 decides connection base station information based on the positional information input from the positional information detection unit 101-1 (step S105 in FIG. 3).

The connection base station decision unit 101-2 notifies the connection base station of a connection request through the backhaul line (step S106 in FIG. 3), and receives a connection permission notification from the connection base station (step S107 in FIG. 3). The exchange of information with another base station as in step S106 and step S107 may be performed between the higher layer 101 of the macro cell base station and the higher layer 101 of the low power base station through the backhaul line, and is not limited to the connection base station decision unit 101-2.

When the permission notification from the terminal 300 is a notification indicating that a handover is permitted (for example, handover request ACK), the macro cell base station 100 changes the connection destination of the terminal 300. In this case, the connection base station decision unit 101-2 outputs the connection base station information to the information data generation unit 101-3. If there is transmit data other than the connection base station information (data to be transmitted by the higher layer 101 to the terminal 300 other than the connection base station information), the positional information detection unit 101-1 outputs that data to the information data generation unit 101-3. The information data generation unit 101-3 converts the input connection base station information and transmit data other than the connection base station information to a predetermined signal format, and provides resultant data as downward information data. The downward information data includes data to be transferred from a medium access control (MAC) layer to a physical layer and parameters set in a radio resource control (RRC) layer that controls these parameters. The information data generation unit 101-3 outputs the downward information data to the physical layer control unit 102.

On the other hand, when the permission notification from the terminal 300 is a notification indicating that a handover is not permitted (for example, handover request NACK), the macro cell base station 100 does not change the connection destination of the terminal 300. In this case, the positional information detection unit 101-1 outputs transmit data other than the connection base station information to the information data generation unit 101-3, and the information data generation unit 101-3 provides only the input transmit data other than the connection base station information as downward information data, and outputs the downward information data to the physical layer control unit 102.

In this way, only when the macro cell base station 100 changes the connection destination of the terminal 300, the higher layer 101 generates downward data information about the connection base station information (step S108 in FIG. 3).

The physical layer control unit 102 outputs the downward information data input from the information data generation unit 101-3 to the coding unit 103. The physical layer control unit 102 decides a reference signal generation pattern based on the control information input from the control information detection unit 123, and outputs the reference signal generation pattern to the reference signal generation unit 105. The physical layer control unit 102 outputs the control information input from the control information detection unit 123 to the control signal generation unit 106.

The coding unit 103 performs error correction coding for the downward information data input from the information data generation unit 101-3. A coding method used by the coding unit 103 for error correction coding is, for example, turbo coding, convolutional coding, low density parity check coding (LDPC), or the like. To match the coding rate of the data sequence subjected to error correction coding with a coding rate corresponding to a data transmission rate, the coding unit 103 may perform rate matching processing for the coded bit sequence. The coding unit 103 may have a function of sorting and interleaving the data sequence subjected to error correction coding.

The modulation unit 104 modulates a signal input from the coding unit 103 to generate a modulation symbol. Modulation processing performed by the modulation unit 104 is, for example, binary phase shift keying (BPSK), quadrature phase shift keying (QPSK), quadrature amplitude modulation (QAM), or the like. The modulation unit 104 may have a function of sorting and interleaving the generated modulation symbols.

The reference signal generation unit 105 generates a reference signal (pilot signal), and outputs the generated reference signal to the resource mapping unit 108. The reference signal is used to perform the following from the macro cell base station 100 for the terminal 300: channel performance estimation, reception power measurement, positioning, and the like.

The control signal generation unit 106 generates a control signal from the control information input from the physical layer control unit 102. The control signal may be subjected to error correction coding and modulation processing.

The synchronization signal generation unit 107 generates a synchronization signal from a cell ID in accordance with a rule predetermined in the system.

The resource mapping unit 108 maps the modulation symbol, reference signal, control signal, and synchronization signal to resource elements based on resource allocation information generated by the control information generation unit 106 (referred to as resource mapping).

The IFFT unit 109 performs an inverse fast Fourier transform (IFFT) for a frequency domain signal input from the resource mapping unit 108 to convert the signal to a time domain signal. Instead of an IFFT, the IFFT unit 109 may use another processing method, for example, an inverse discrete Fourier transform (IDFT), provided that a frequency domain signal can be converted to a time domain signal.

The CP insertion unit 110 adds a cyclic prefix (CP) to the time domain signal (referred to as an effective symbol) input from the IFFT unit 109 to generate an OFDM symbol. The CP is a guard interval added to avoid multi-path interference caused by a delay wave.

The transmission unit 111 converts the OFDM symbol input from the CP insertion unit 110 from a digital signal to an analog signal (digital to analog conversion (D/A conversion)). The transmission unit 111 band-limits the generated analog signal by filtering processing, generates a band-limited signal, up-converts the generated band-limited signal to a radio frequency band, and transmits the signal from the transmit antenna unit 112.

The low power base station 200-x in the present embodiment will next be described with reference to FIG. 5.

The low power base station 200-x has the same configuration as the macro cell base station 100, but is different in processing in the higher layer 101.

The higher layer 101 is notified of a connection request from the macro cell base station 100 through the backhaul line (step S106 in FIG. 3). The higher layer 101 determines whether a connection to the terminal 300 is possible, and notifies the macro cell base station 100 of a permission notification (handover request ACK/NACK) (step S107 in FIG. 3).

Because the low power base station 200-x does not decide connection base station information, in the higher layer 101, as in the case in which the macro cell base station 100 does not change the connection destination of the terminal 300, the information data generation unit 101-3 provides only data to be transmitted by the higher layer 101 to the terminal 300 as downward information data, and outputs the downward information data to the physical layer control unit 102.

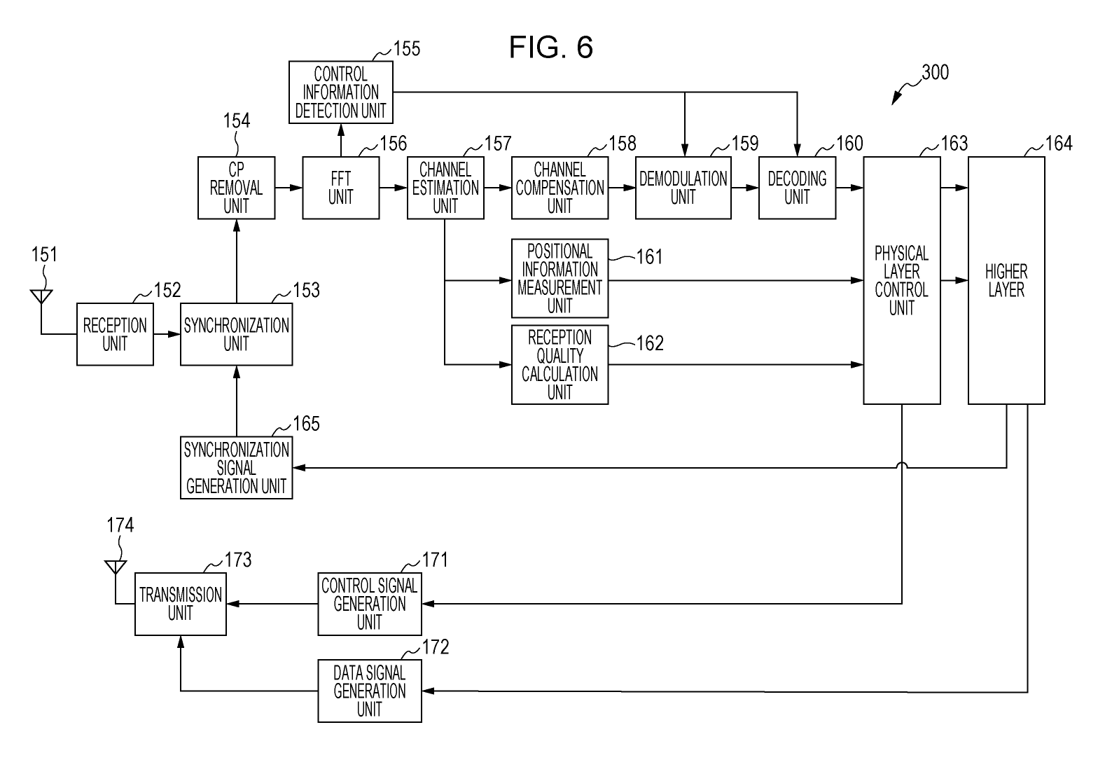

The terminal 300 in the present embodiment will next be described. FIG. 6 is a schematic block diagram illustrating a configuration example of the terminal 300 in the first embodiment.

The terminal 300 includes a receive antenna unit 151, a reception unit 152, a synchronization unit 153, a CP removal unit 154, a control information detection unit 155, an FFT unit 156, a channel estimation unit 157, a channel compensation unit 158, a demodulation unit 159, a decoding unit 160, a positional information measurement unit 161, a reception quality calculation unit 162, a physical layer control unit 163, a higher layer 164, a control signal generation unit 171, a data signal generation unit 172, a transmission unit 173, and a transmit antenna unit 174. When part or all of the terminal 300 is contained on a chip as an integrated circuit, a chip control circuit (not illustrated) that controls the functional blocks is provided. One transmit antenna and one receive antenna are illustrated in FIG. 6, but a plurality of transmit antennas and a plurality of receive antennas may be provided.

The terminal 300 receives signals transmitted from the macro cell base station 100 and the low power base station 200-x through the receive antenna unit 151.

The reception unit 152 down-converts the radio frequency signal input from the receive antenna unit 151 to a frequency band in which digital signal processing is possible, and then performs filtering processing. The reception unit 152 performs A/D conversion of the signal subjected to filtering processing from an analog signal to a digital signal, and outputs the converted digital signal to the synchronization unit 153.

When a synchronization signal of the macro cell 10 is detected, the reception unit 152 matches the radio frequency with a frequency allocated to the macro cell and detects a radio frequency signal.

The synchronization signal generation unit 165 generates in advance a synchronization signal corresponding to the macro cell.

The synchronization unit 153 performs synchronization from the signal input from the reception unit 152. When the synchronization is completed, the synchronization unit 153 outputs the received signal to the CP removal unit 154.

As has been described above, when synchronization with the macro cell base station 100 is performed, a cell search and synchronization are performed, and when a connection with the macro cell base station 100 has been completed and communication with the macro cell base station 100 is being performed, this processing is skipped. When connection base station information has been notified from the macro cell base station 100, synchronization with the low power base station is performed.

To avoid distortion due to a delay wave, the CP removal unit 154 removes a CP from the signal output from the reception unit. Then, the CP removal unit 154 outputs the signal with the CP removed to the FFT unit 156.

The FFT unit 156 performs a fast Fourier transform (FFT) for converting the signal input from the CP removal unit 154 from a time domain signal to a frequency domain signal, outputs a modulation symbol and a reference signal to the channel estimation unit 157, and outputs a control signal to the control information detection unit 155. The FFT unit 156 may perform not only an FFT, but also another method, for example, a discrete Fourier transform (DFT) or the like, provided that a signal can be converted from a time domain to a frequency domain.

The channel estimation unit 157 demaps the reference signal (pilot signal for channel estimation) included in the signal output by the FFT unit 156, and performs channel estimation using the pilot signal. The channel estimation unit 157 outputs estimated channel information to the channel compensation unit 158, the positional information measurement unit 161, and the reception quality calculation unit 162.

The control information detection unit 155 detects the control information included in the signal output by the reception unit 152. The control information detection unit 155 extracts various information such as resource block allocation information, MCS information, HARQ information, and TPC information included in the control information. Then, the control information detection unit 155 detects the extracted various information, and outputs the information to the demodulation unit 159 and the decoding unit 160.

Based on the channel estimation value input from the channel estimation unit 157, the channel compensation unit 158 calculates a weight coefficient for correcting channel distortion due to fading, using a method such as zero forcing (ZF) equalization or minimum mean square error (MMSE) equalization, and performs channel compensation for the input modulation symbol.

The demodulation unit 159 performs demodulation processing for the signal after channel compensation input from the channel compensation unit 158. The demodulation processing may be a hard decision (coded bit sequence calculation) or a soft decision (coded bit LLR calculation).

The decoding unit 160 performs error correction decoding processing for the coded bit sequence (or coded bit LLR) after demodulation output by the demodulation unit 159, calculates downward information data, and outputs the downward information data to the physical layer control unit 163. At this time, the decoded information data includes connection base station information. A method of this error correction decoding processing is a method corresponding to the error correction coding such as turbo coding or convolutional coding performed by the connected base station. As error correction decoding processing, a hard decision or a soft decision is applicable. When the base station transmits interleaved data modulation symbols, the decoding unit 160 performs, for the input coded bit sequence, deinterleaving processing corresponding to interleaving before performing error correction decoding processing. Then, the decoding unit 160 performs error correction decoding processing for the signals subjected to deinterleaving processing.

The positional information measurement unit 161 measures positional information of the terminal 300 based on the channel information input from the channel estimation unit 157 (step S103 in FIG. 3), and outputs the positional information to the physical layer control unit 163. The positional information may be calculated not only by the channel information, but also by another method.

The reception quality calculation unit 162 calculates reception quality based on the channel information input from the channel estimation unit 157, and outputs the reception quality to the physical layer control unit 163.

The physical layer control unit 163 outputs the input downward information data (such as connection base station information) and positional information to the higher layer 164. The physical layer control unit 163 provides the input reception quality and the like as control information, and outputs the control information to the control signal generation unit 171. Of the information input to the physical layer control unit 163, the information to be managed by the higher layer 164 may be output to the higher layer 164, and allocation of the information to be managed by the physical layer control unit 163 and the higher layer 164 is not limited thereto.

The higher layer 164 provides the data to be transmitted to the higher layer 101 and the positional information as upward information data, and outputs the upward information data to the data signal generation unit 172.

The control signal generation unit 171 performs error correction coding and modulation mapping for the input control information to generate a control signal.

The data signal generation unit 172 performs error correction coding and modulation mapping for the input upward information data to generate an upward data signal.

The signal including the control signal input from the control signal generation unit 171 and the upward data signal input from the data signal generation unit 172 is subjected to D/A conversion in the transmission unit 173, up-converted to a frequency band in which transmission is possible in the uplink, and transmitted through the transmit antenna unit 174 to the base station of the cell to be connected.

The synchronization signal generation unit 165 generates a synchronization signal based on the input connection base station information, and outputs the synchronization signal to the synchronization unit 153. This enables detection of a signal from a base station indicated in connection base station information in the next reception processing.

Thus, in the terminal 300 in the present embodiment, in steps S101 to S104 in FIG. 3, the reception unit 152 makes a cell search using the frequency of the macro cell 10, and receives a signal transmitted from the macro cell base station 100, and the synchronization unit 153 synchronizes with a synchronization signal (step S101 in FIG. 3). At this time, the higher layer 164 is notified of the cell ID determined as having the highest reception power, and a connection to the macro cell base station 100 is completed (step S102 in FIG. 3). The positional information measurement unit 161 measures positional information from a reference signal included in the receive signal (step S103 in FIG. 3). The data signal generation unit 172 generates an upward data signal including positional information, and transmits the positional information to the macro cell base station 100 through the transmit antenna 174 (step S104 in FIG. 3).

In steps S108 to S110 in FIG. 3, the reception unit 152 receives a signal transmitted from the macro cell base station 100 using the frequency of the macro cell 10 (step S108 in FIG. 3). At this time, because the connection to the macro cell 10 has been completed, the synchronization unit 153 does not do anything (not illustrated). Connection base station information included in downward information data is output to the synchronization signal generation unit 165, the synchronization signal generation unit 165 generates a synchronization signal corresponding to the connection base station information, and thereby a search is made for a connection base station and a connection to the small cell base station 200-x specified by the macro cell base station 100 can be made (steps S109 and S110 in FIG. 3).

Thus, in the present embodiment, the terminal 300 connects to the macro cell base station 100, and notifies the macro cell base station 100 of positional information of the terminal 300. The macro cell base station 100 decides a connection base station based on the notified positional information, and the terminal 300 switches the connection destination from the macro cell base station 100 to the connection base station. Accordingly, the terminal 300 has only to detect a synchronization signal from the macro cell base station and a measurement signal of the connection base station, and it is therefore possible to reduce signal detection processing and change the connection destination efficiently.

### Second Embodiment

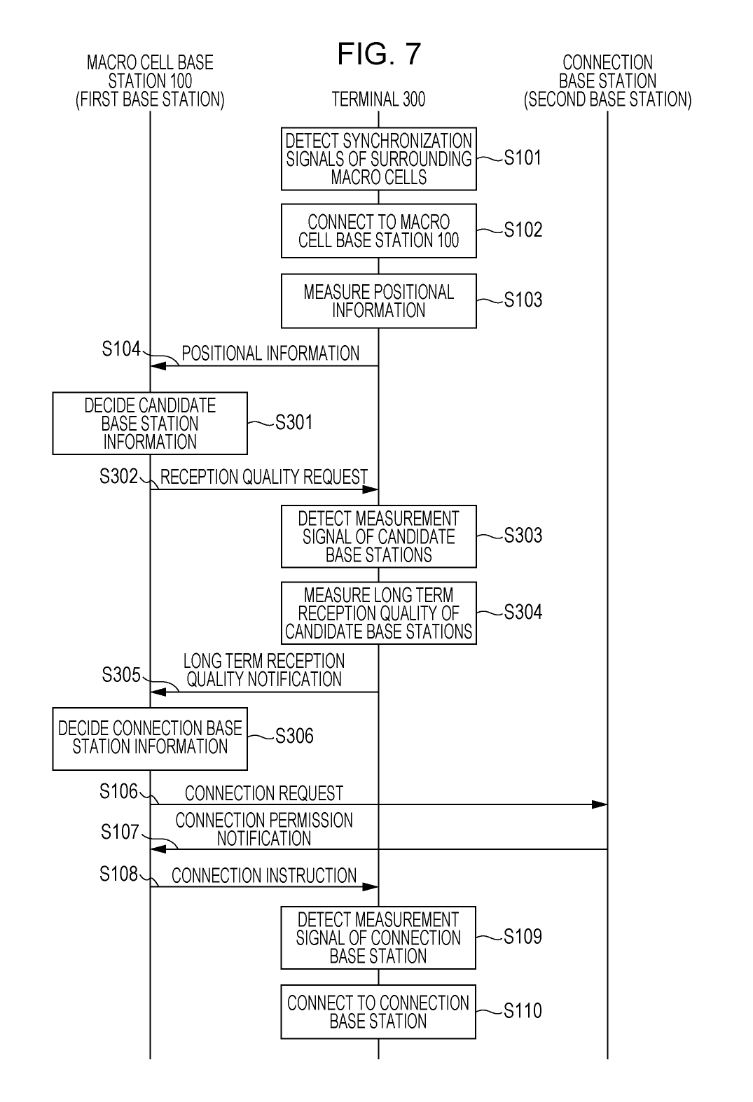

A processing flow in the present embodiment will be described. FIG. 7 is a sequence diagram illustrating an example of the processing flow in a communication system in the present embodiment. The configuration of the communication system, the macro cell base station 100, the low power base station 200-x, and the terminal 300 in the present embodiment is similar to that of the first embodiment. Only differences from the first embodiment will now be described.

In FIG. 7, the processing denoted by the same reference signs as those in FIG. 3 (step S101 to step S104 and step S106 to step S110) is similar to the processing in the first embodiment.

The macro cell base station 100 decides candidate base stations based on positional information notified from the terminal 300 (step S301). The candidate base stations refer to a plurality of base stations that are candidates for a base station to be connected. For the candidate base stations, it is preferable that a distance between the positional information of the terminal 300 and each low power base station 200-x is calculated, and the cell IDs of a plurality of low power base stations 200-x having shorter distances are provided as candidate base station information. For example, in FIG. 1, two cells having shorter distances to the terminal 300 are selected, and candidate base station information is the cell IDs of 20-1 and 20-4. The number of candidate base stations may be preset. Alternatively, a threshold value may be preset, and if a distance between the terminal 300 and a low power base station 200-x does not exceed the threshold value, the base station may be included in the candidate base stations. The candidate base station information has only to be information with which a cell or a base station can be identified as a connection destination, and is not limited to cell IDs. As in the first embodiment, the macro cell base station 100 may measure a connection state of the terminal 300, and decide candidate base stations in consideration of the measurement result.

The macro cell base station 100 requests reception quality from the terminal 300 (step S302).

The terminal 300 detects measurement signals transmitted from candidate base stations, among the measurement signals transmitted from the base stations of surrounding cells (step S303). The terminal 300 measures long term reception quality from the cell-specific measurement signals (step S304). The reception quality may be an indication of reception quality of a signal transmitted to the terminal 300 by each base station, such as reception power or reception signal to interference plus noise power ratio (SINR), and is preferably reception quality observed for the long term. The terminal 300 notifies the macro cell base station 100 of cell-specific long term reception quality (step 305).

The macro cell base station 100 decides a connection base station based on the cell-specific long term reception quality notified from the terminal 300 (step S306). It is desirable for the macro cell base station 100 to select the small cell 20-x having the best reception quality. For example, when the low power base station 200-1 and the low power base station 200-4 have reception power of 1 [dBm] and 4[dBm], respectively, the low power base station 200-4, which is the base station having the highest reception power (the best long term reception quality), is specified as a connection base station.

The macro cell base station 100 instructs the terminal 300 to change the connection destination from the macro cell base station 100 to the connection base station decided in step S306 (step S106).

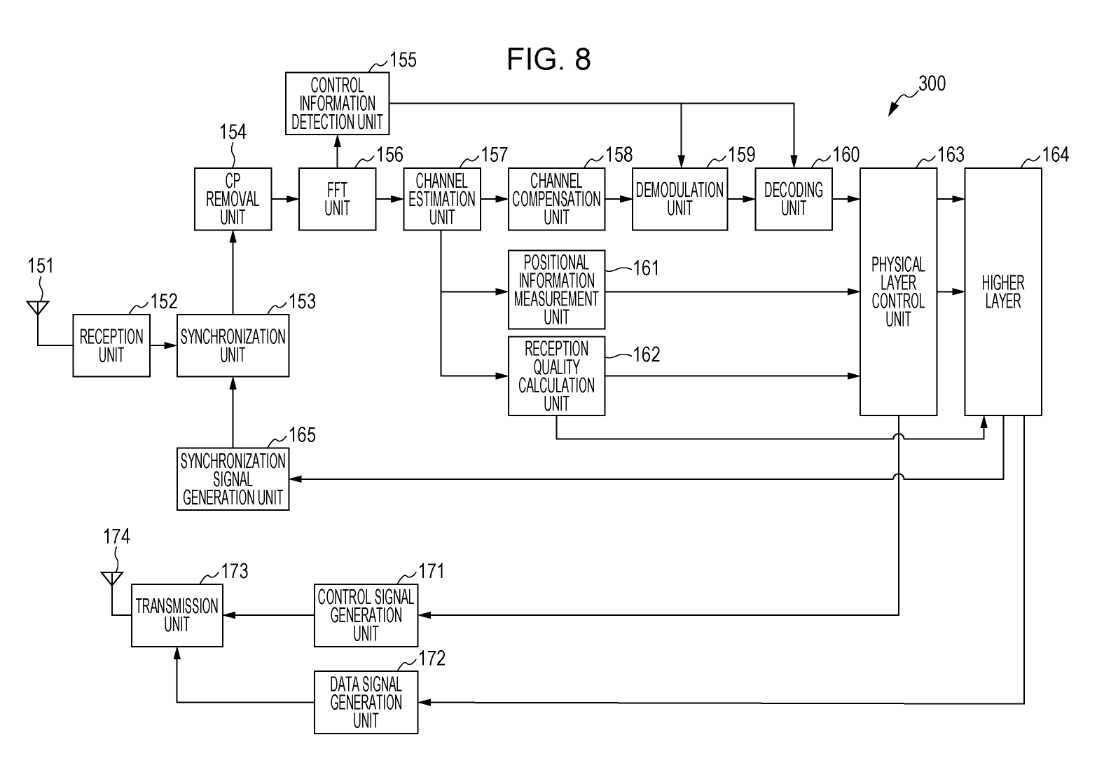

The terminal 300 in the present embodiment will next be described. FIG. 8 is a schematic block diagram illustrating a configuration example of the terminal 300 in the second embodiment.

FIG. 8 shows a configuration similar to that in FIG. 6, but is different from FIG. 6 in that the reception quality calculation unit 162 measures reception quality from measurement signals transmitted from candidate base stations and outputs the reception quality to the higher layer, and the higher layer 164 calculates long term reception quality from the input reception quality and outputs the long term reception quality to the data signal generation unit 172, and the long term reception quality is transmitted to the macro cell base station 100. The long term reception quality is obtained by filtering (for example, averaging) reception quality measured by the reception quality calculation unit 162.

Thus, in the present embodiment, the macro cell base station 100 decides candidate base stations, which are candidates for a connection destination, based on positional information, and decides a connection base station based on long term reception quality of the connection candidate base stations notified from the terminal 300. Because the reception quality depends on, for example, a state of communication with another terminal, a more suitable connection destination can be decided, as compared with the case in which a connection base station is decided only from positional information. Therefore, when the present embodiment is used, it is possible to improve a macro area capacity while reducing signal detection processing required for a cell search.

### Third Embodiment

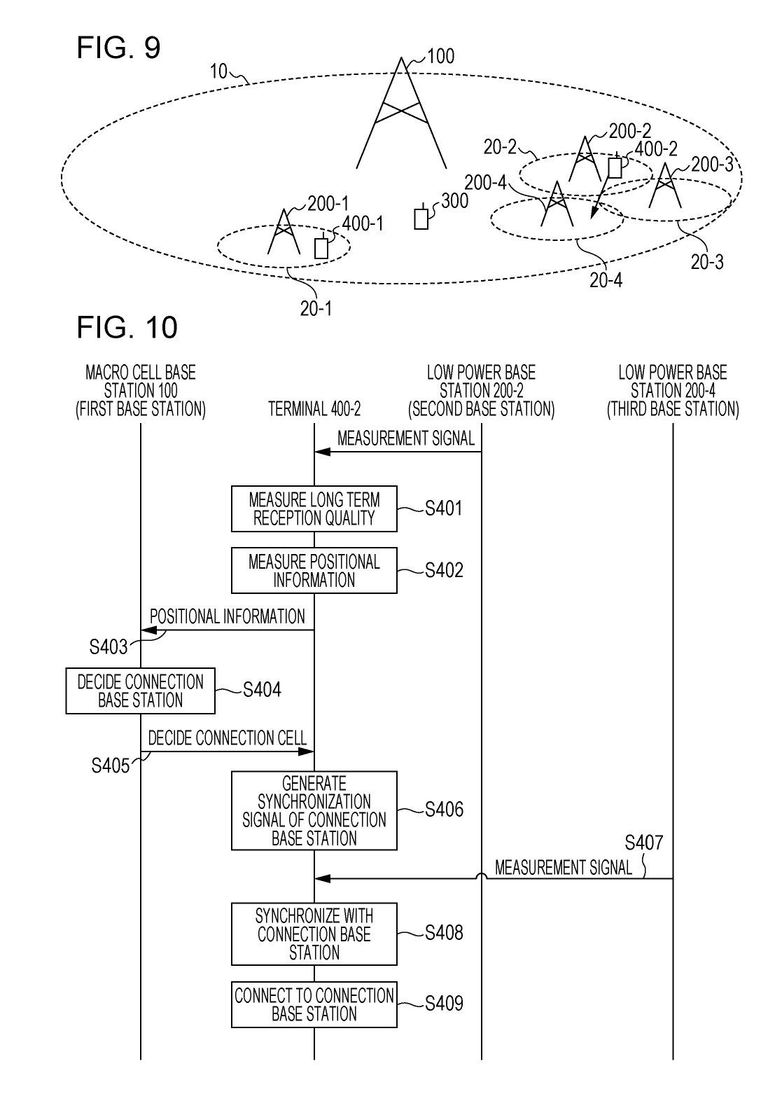

FIG. 9 is a schematic view illustrating a configuration example of a communication system in a third embodiment. In FIG. 9, consider the case in which the terminal 400-2 moves in the direction of an arrow, from the small cell 20-2 covered by the low power base station 200-2 (second base station) to the small cell 20-4 covered by the low power base station 200-4 (third base station). The terminal 400-2 connects to the low power base station 200-2 based on the method in the first embodiment or the second embodiment.

At this time, when the terminal 400-2 moves to the small cell, the connection must be switched to the low power base station 200-4. The present embodiment provides a method for switching the connection in such an environment.

FIG. 10 is a sequence diagram illustrating an example of a processing flow in the communication system in the present embodiment. It is assumed here that the terminal 400-2 has already connected to the low power base station 200-2 and changes the connection to the low power base station 200-4.

First, the terminal 400-2 receives a measurement signal from the low power base station 200-2, and measures reception quality (step S401). At this time, if the measured reception quality is lower than or equal to a threshold value, the terminal 400-2 determines that the terminal 400-2 should connect to another base station, and generates positional information (step S402). The positional information is transmitted to the macro base station 100 (step S403). After receiving the positional information, the base station 100 decides a connection base station (step S404), and transmits information of the decided connection base station to the terminal 400-2 (step S405). Then, the terminal 400-2 generates a synchronization signal of the connection base station based on the notified connection base station information (step S406). Then, the low power base station 20-4 transmits a measurement signal (step S407), and the terminal 400-2 synchronizes with the measurement signal (step S408), and connects to the connection base station (step S409). The measurement signal transmitted in step S407 may be transmitted periodically or autonomously by the low power base station 200-4, and a transmission timing of the measurement signal of the low power base station is not limited.

Thus, when the present embodiment is applied, it is possible to switch the connection to another small cell efficiently.

In the present embodiment, a terminal determines a handover between small cells. However, for example, when a low power base station determines that a terminal should connect to another base station, a macro cell base station may request a redetermination of the connection.

A program running on a base station and a terminal according to the present invention is a program that controls a CPU and the like so as to implement functions of the above embodiments according to the present invention (program for causing a computer to function). Information handled by these devices is temporarily stored in a RAM when it is processed. Then, the information is stored in various types of ROM or HDD, and read, modified, written by the CPU as necessary. A recording medium for storing the program may be any of semiconductor media (for example, ROM, nonvolatile memory cards, and the like), optical recording media (for example, DVD, MO, MD, CD, BD, and the like), magnetic recording media (for example, magnetic tapes, flexible disks, and the like), and others. Running the loaded program implements the functions of the embodiments described above, and may further implement the functions of the present invention by executing processing jointly with the operating system, other application programs, or the like based on instructions from the program.

To distribute the program on the market, a portable recording medium with the program stored on it may be distributed, or the program may be transferred to a server computer connected through a network such as the Internet. In this case, a storage device of the server computer is also included in the present invention. Part or all of the base stations and the terminals in the embodiments described above may typically be implemented as LSI chips, which are integrated circuits. An each individual functional block of the base stations and the terminals may be contained on a chip, or some or all functional blocks may be integrated and contained on a chip. The integrated circuit technique is not limited to LSI, and the base stations and the terminals may be implemented with dedicated circuits or general-purpose processors. When the functional blocks are contained on integrated circuits, an integrated circuit control unit that controls the functional blocks is added.

The integrated circuit technique is not limited to LSI, and the base stations and the terminals may be implemented with dedicated circuits or general-purpose processors. In addition, if an integrated circuit technology that replaces LSI emerges with the advance of the semiconductor technology, integrated circuits based on that technology may be used.

The present invention is not limited to the embodiments described above. It will be appreciated that the terminals in the present invention may be applied not only to mobile station devices, but also to stationary or non-movable electronic equipment installed indoors or outdoors, for example, AV equipment, kitchen equipment, cleaning and washing equipment, air conditioning equipment, office equipment, vending machines, other daily living equipment, and the like.

Although embodiments of the present invention have been described in detail above with reference to the drawings, specific configurations are not limited to these embodiments, and design changes and the like not departing from the spirit of the present invention are also included. In the present invention, various changes may be made within the scope indicated in the claims, and embodiments obtained by combining technical measures disclosed in different embodiments as appropriate are also included in the technical scope of the present invention. Configurations in which the components that are described in the above embodiments and have similar effects are replaced with each other are also included.

### INDUSTRIAL APPLICABILITY

The present invention is suitable for use in wireless base stations, wireless terminals, wireless communication systems, and wireless communication methods.

### REFERENCE SIGNS LIST

10 macro cell
100 macro cell base station
20-1, 20-2, 20-3, 20-4 small cell
200-1, 200-2, 200-3, 200-4 low power base station
300 terminal
101 higher layer
101-1 positional information detection unit
101-2 connection base station decision unit
101-3 information data generation unit
102 physical layer control unit
103 coding unit
104 modulation unit
105 reference signal generation unit
106 control signal generation unit
107 synchronization signal generation unit
108 resource mapping unit
109 IFFT unit
110 CP insertion unit
111 transmission unit
112 transmit antenna unit
121 receive antenna unit
122 reception unit
123 control information detection unit
124 information data detection unit
151 receive antenna unit
152 reception unit
153 synchronization unit
154 CP removal unit
155 control information detection unit
156 FFT unit
157 channel estimation unit
158 channel compensation unit
159 demodulation unit
160 decoding unit
161 positional information measurement unit
162 reception quality calculation unit
163 physical layer control unit
164 higher layer
165 synchronization signal generation unit
171 control signal generation unit
172 data signal generation unit
173 transmission unit
174 transmit antenna unit

1-17. (canceled)

18. A terminal that communicates with a base station,
wherein the terminal calculates terminal information indicating a position of the terminal, and transmits the terminal information to a first base station via an uplink control channel, the terminal information being included in a control signal.

19. The terminal according to claim 18,
wherein the terminal information is information obtained by a positioning reference signal.

20. The terminal according to claim 18,
wherein the terminal information is reception quality.

21. The terminal according to claim 18,
wherein the terminal performs a cell search and synchronization in a case that the terminal starts communication with the first base station, and the terminal performs synchronization in a case that the terminal is instructed by the first base station to communicate with a second base station.

22. The terminal according to claim 18,
wherein the terminal synchronizes with a plurality of second base stations notified from the first base station, and measures reception quality.

23. The terminal according to claim 18,
wherein the terminal synchronizes with a plurality of second base stations notified from the first base station, and measures reception quality, and
the terminal notifies the first base station of information about the measured reception quality of all second base stations.

24. The terminal according to claim 18,
wherein in a case that reception quality in communication with the second base station becomes smaller than or equal to a predetermined value, the terminal transmits terminal information to the first base station, and starts communication with a third base station based on information transmitted from the first base station.

25. A base station that controls a terminal,
wherein the base station receives a control signal transmitted from the terminal via an uplink control channel, detects terminal information included in the control signal, and transmits connection base station information to the terminal.

26. The base station according to claim 25,
wherein the terminal information is information obtained by a positioning reference signal.

27. The base station according to claim 25,
wherein the terminal information is reception quality.

28. The base station according to claim 25,
wherein the base station transmits candidate base stations to the terminal, receives reception quality from the terminal, and transmits connection base station information to the terminal.

29. A communication method for use in a terminal that communicates with a base station, comprising:
a means of calculating terminal information indicating a position of the terminal; and
a means of transmitting the terminal information to a first base station via an uplink control channel, the terminal information being included in a control signal.
